(19) United States
(12) Patent Application Publication
(10) Pub. No.: US 2002/0050196 A1
(43) Pub. Date: May 2, 2002

(54) Saw blade and method of producing a saw blade

(75) Inventors: Manfred Fluhrer, Spangenberg (DE); Jorg H. Kullmann, Spangenberg (DE)

Correspondence Address: George M. Thomas, Thomas, Kayden, Hostemeyer & Risley, LLP, Suite 1750, 100 Galleria Parkway, NW., Atlanta, GA, 30339-5948, US

(73) Assignee: WIKUS -Sagenfabrik Wilhelm H. Kullmann GmbH & Co. KG

(21) Appl. No.: 10/021,235

(22) Filed: Oct. 30, 2001

(30) Foreign Application Priority Data
Nov. 2, 2000 (DE) 100 54 296.4-14

(51) Int. Cl. B26D 1/00; B27B 33/02

(52) U.S. Cl. 83/13; 83/835

(57) ABSTRACT

The saw blade (1) includes an elongated body (2) having a longitudinal edge and defining a plane of main extension (6). A plurality of protrusions (4) each is located in the region of the longitudinal edge and each includes a seat (12). A plurality of form bodies (5) each is made of hard cutting material, has a cross section (15) and is connected to one of the seats (12). Each cross section (15) of the form bodies (5) in the plane of main extension (6) at a side facing the respective seat (5) is limited by a line (16) in the form of a circular arc, and at a side facing away from the respective seat (5) it is limited by a front line (17) of a surface (18). The line (16) in the form of a circular arc and the front line (17) enclose a wedge angle (22) which is less than approximately 90 degrees, and they are designed and arranged to form a free angle (23). A plurality of cutting portions (10) each extends approximately transverse with respect to the plane of main extension (6). A plurality of teeth (3) each is formed by one of the protrusions (4) and the respective form body (5). A method serves to manufacture the saw blade (1).

### CROSS REFERENCE TO RELATED APPLICATIONS

This application claims the benefit of co-pending German Patent Application No. 100 54 296 “Sägeband und Verfahren zu seiner Herstellung” filed on Nov. 2, 2000.

### FIELD OF THE INVENTION

The present invention generally relates to a saw blade. More particularly, the present invention relates to a saw blade for cutting abrasive materials. Especially, the surface of a tooth of the saw blade may be ground. The present invention is not limited to a saw blade substantially extending straight. It may also be used in circular saw blades. The novel saw blade is especially used to separate abrasive materials. Abrasive materials are to be understood as hard and brittle materials, such as building blocks, pore blocks, graphite and the like of which no chips, but rather broken pieces of irregular shape are taken off during sawing.

### BACKGROUND OF THE INVENTION

A saw blade is known from German Patent No. 33 07 170 C2. The known saw blade includes a band-like body and a number of teeth being located at its longitudinal edge. Each tooth is located on a protrusion at which a seat is formed. A form body made of hard cutting material is connected to the seat. Plates of cutting material are used as form bodies. They have the shape of plates for parallelepides, and they are ready to use. Before the plates of cutting material are connected to the protrusions, they may be ground at all sides in the sense of the required free cuts and the free angles, respectively, at the back of the tooth and at the tooth flanks to form plain surfaces. Different effective cutting angles may be realized by different ways of fixing them to the protrusions. However, it is also possible to grind the plates of cutting material after they have been connected to the protrusions. The grinding process of the form bodies being designed as plates of cutting material—no matter whether before or after their connection to the protrusion—is an expensive process in the region of the phase of the tooth, the back of the tooth and the two flanks of the tooth which requires several steps. Each form body attains a defined shape which is limited by plain surfaces and having a cross section which is approximately rectangular in the plain of main extension of the saw blade. A defined cutting portion extending in a direction transverse to the plain of main extension is formed. The form bodies may be made of hard metal, rapid steel, ceramic cutting material, sintered material including diamond particles and the like. During grinding, 30 to 70 percent of this material which is expensive compared to the material of the body are removed.

Similar saw blades are known from European Patent Application 0 266 022 A2 and from U.S. Pat. No. 4,011,783. The known saw blades include teeth of the known pre-cutting and after-cutting technology to remove the chips from the cutting channel in three portions. Parallelepide-shaped blocks of tungsten carbide, for example, are used as form bodies, and they are connected to the protrusions by soldering. Then, the form bodies and the protrusions are differently ground to form the pre-cutting teeth and the after-cutting teeth producing the free angles in the region of the phase of the tooth, the back of the tooth and the two flanks of the tooth in a complicated way.

### SUMMARY OF THE INVENTION

The present invention relates to a saw blade. The saw blade includes an elongated body having a longitudinal edge and defining a plane of main extension. A plurality of protrusions each is located in the region of the longitudinal edge and each includes a seat. A plurality of form bodies each is made of hard cutting material, has a cross section and is connected to one of the seats. Each cross section of the form bodies in the plane of main extension at a side facing the respective seat is limited by a line in the form of a circular arc, and at a side facing away from the respective seat it is limited by a front line of a surface. The line in the form of a circular arc and the front line enclose a wedge angle which is less than approximately 90 degrees, and they are designed and arranged to form a free angle. A plurality of cutting portions each extends approximately transverse with respect to the plane of main extension. A plurality of teeth each is formed by one of the protrusions and the respective form body. The novel saw blade may be manufactured at low costs.

In the novel saw blade, the form bodies at least have a partially “round” design. The form body may be designed as a ball, a part of a ball, a cylinder or a part of a cylinder which is inserted into and connected to, respectively, the respective protrusion being located at the body of the saw blade. A ball may be easily connected to the protrusion since it does not matter in what way and at what angle it is grasped. It is always located in the right position. In case of a part of a ball, for example a semi-ball, the position of the surface which separates the ball is to be taken into account. In case of a cylinder, its axis has to be additionally taken into account. In case of a part of a cylinder, its axis and the position of the surface which separates the cylinder has to be taken into account. When one uses a form body with such at least partially round design a defined cutting portion including a cutting edge extending in a direction transverse to the plain of main extension results from one single surface. This only surface may be the surface which separates the ball or the cylinder and/or it may be produced by one single grinding process which is conducted at the form body before or after its connection to the body of the saw blade. The surface may be shaped during manufacture of the form body, for example by pressing and sintering of the form body carrying the surface. This one single surface may be designed as a plain surface or, for example, as a band surface. On the other hand, a free surface with a free angle automatically results from the remaining surface of the form body during its connection on the protrusion. The free surface further has the advantage of being designed as a ball surface or as a cylinder area surface. Wear marks unpreventively occurring during use of the saw blade have a shorter extension in a direction opposite the band running direction than it is the case with a plain free surface.

The circular arc line formed by the cross section of the form body and the front line of the form body provided by the surface enclose a wedge angle which is not substantially more than 90 degrees. In case of a cutting angle of 0 degrees, the wedge angle may not be more than 90 degrees. In case of a positive cutting angle, it is less than 90 degrees. When the cutting angle is negative, the wedge angle may be more than 90 degrees. In all cases, the surface has to be arranged in a way that a free angle results at the tooth being formed by the form body. The free angle and the free surface, respectively, at least extends in the region of the back of the tooth. When a ball is used, the free angles and the free surfaces, respectively, even extend over the region of the flanks.

It is especially preferred to use less than a semi ball and/or to realize less than a semi ball at the finished tooth after grinding. The cutting portion with its cutting edge extending in the shape of an arc does not only have a free surface in the shape of the surface of a ball in the region of the back of the tooth and of the flanks. Additionally, a flank angle of 180 degrees and a flank free angle in a direction perpendicular to the band running direction of 0 degrees automatically result. The flank free angle in the band running direction is more than 0 degrees, for example approximately 5 degrees, for example when a semi ball is inserted as form body at this place. This contour of the flanks is especially preferred for long usable times of the saw blade and for a special surface quality of the cut surfaces in the cutting channel. Similar advantages result from the use of a cylindrical form body in which the transitions between the surface area and the phases have a rounded design. In case the phases of the cylindrical form body are designed as ball surfaces, the same advantages are achieved in combination with setting the tooth as it is the case during use of a ball.

The present invention also relates to a method of producing a saw blade. The novel method includes the steps of forming a plurality of protrusions at a longitudinal edge of an elongated body, forming a seat at each of the protrusions, connecting a form body being made of hard cutting material to each of the seats, forming a surface at each of the form bodies at a side facing away from the respective seat to form a cutting portion of a tooth, and connecting a round element to each seat in a way that the cutting portion has a wedge angle which is less than approximately 90 degrees and a free angle is formed. The novel method of manufacturing a novel saw blade is easy to be conducted.

In case of a positive cutting angle, the wedge angle is less than 90 degrees. The free angle at the head of the tooth and the flank free angle may be comparatively little since the surfaces of the form body which form the free angle increasingly reseat against the band running direction in a stronger way than it is the case with plain surface.

It is especially preferred to grind the form body only at the side facing away from the seat.

The only grinding process is conducted at the form body before or after its connection to the body. It is to be understood that different effective cutting angles may be attained by grinding. To realize the pre-cutting and after-cutting technology, ball-like and cylindrical form bodies may be alternately located on the protrusions of the novel saw blade. It is also possible to realize groups of teeth including more than two teeth in the sense of a variation of heights and widths. The diameter of the ball and the length of the cylinder with respect to the thickness of the body are to be taken into account. In case balls are used the diameter of which is substantially more than the thickness of the body or when cylinders are used the length of which is more than the thickness of the body and which are limited by semi balls, for example, straight teeth, meaning unset teeth, may be used. In case balls are used the diameter of which is slightly more than the thickness of the body or when cylinders are used the length of which is slightly more than the thickness of the body, it may be necessary or desired to set at least some of the teeth.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a partially cut side view of the novel saw blade in the region of a tooth.

FIG. 2 is a front view of a first exemplary embodiment of the tooth.

FIG. 3 is a front view of a second exemplary embodiment of the tooth.

FIG. 4 is a similar view as FIG. 1, but illustrating another exemplary embodiment of the tooth.

FIG. 5 is a front view of a saw blade including a series of three teeth of which two are set.

FIG. 6 is a front view of a saw blade with pre-cutting and after-cutting technology.

FIG. 7 is a front view of another exemplary embodiment of a saw blade.

FIG. 8 is a top view of the saw blade of FIG. 7.

FIG. 9 is a sketch comparing the novel saw blade with the prior art to emphasize the different length of wear marks.

FIG. 10 is a front view of a saw blade including three teeth in the series of teeth.

FIG. 11 is a front view of a saw blade alternately including teeth being set to the left and to the right.

### DETAILED DESCRIPTION

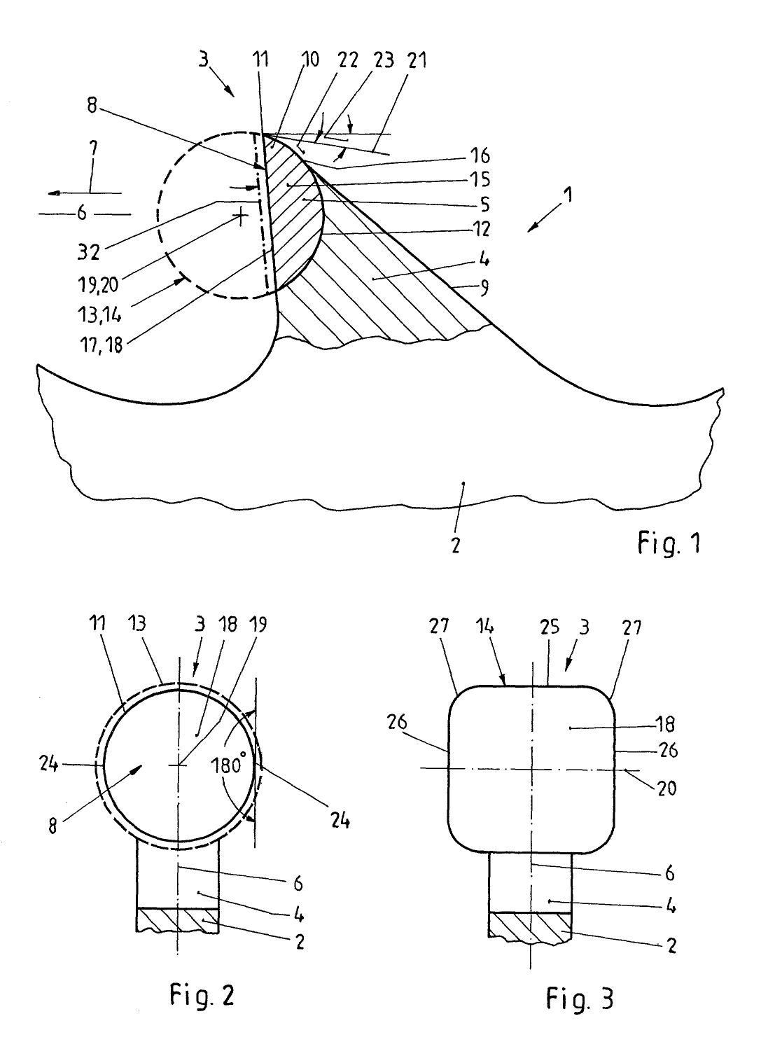

FIG. 1 illustrates a side view of a small section of a saw blade 1. The saw blade 1 includes a body 2 (which is only partially illustrated) the longitudinal edge of which includes teeth 3 of which only one tooth 3 is illustrated for reasons of clarity. The tooth 3 is formed at the body 2 by a protrusion 4 and by a form body 5. A portion of the protrusion 4 and the form body 5 are illustrated in a sectional view. The plane of section corresponds to the plane of illustration, and it is a plane of main extension 6 in which the saw blade 1 is moved according to arrow 7 during cutting (band moving direction). The tooth 3 includes a face 8 and a back 9 as usual. Between the face 8 and the back 9, the form body 5 forms a cutting portion 10 including a cutting edge 11.

The protrusion 4 extends from one rounding to the adjacent rounding in a known fashion. It includes a seat 12 which serves to fix the form body 5. For example, a ball 13, a part of a ball 13, a cylinder 14 or a part of a cylinder 14 may be used as form body 5. Such form bodies are made of hard cutting material, for example of tungsten carbide, hard metal, high-speed steel or other sintered materials including parts of hard cutting material. In the finished saw blade 1, the form body 5 in the from of the ball 13 or the cylinder 14 has a cross section 15 in the plane of main extension 6 in the shape of a sickle. The sickle-shaped cross section 15 of the form body 5 at the side facing the seat 5 is limited or defined in the plane of main extension 6 by a circular arc 16. At the side facing away from the protrusion 4 in the direction of the arrow 7, it is limited by a front line 17. The front line 17 is designed as a straight line, and it is part of a ground surface 18 which extends perpendicular to the plane of main extension 6 and which is part of the face 8. The surface 18 with its front line 17 is designed and arranged such that less than half of the ball 13 and of the cylinder 14, respectively, is located at the finished tooth. This is to be seen in FIG. 1 with respect to the center 19 of the ball 13 and to the axis 20 of the cylinder 14. The surface 18 is the only surface of the tooth 3 which has a ground design or which has been produced like that, for example by a sintering process. Generally, there are two different possible ways of designing the tooth 3. The ball 13 may be connected to the seat 12 as a whole, especially by welding or soldering. Then, most of the ball 13 is ground, and the surface 18 results from that process. Another possibility is to produce the surface 18 at the form body 5 before it is connected to the protrusion 4. Then, the resulting portion of the ball 13 as form body 5 is connected to the seat 12 of the protrusion 4. The front line 17 and the surface 18 do not have to run straight into the material of the protrusion 4, as this is illustrated by a continuous line. To simplify the grinding process, it may be desired to arrange the front line 17 and the surface 18 at the place illustrated by a dash-dotted line 32 in FIG. 1.

In both cases, it has to be made sure that the finished saw blade 1 includes a form body 5 having a sickle shaped cross section 15 being arranged in the necessary and required position with respect to the band running direction according to arrow 7. The surface 18 of the tooth 3 is located at a positive cutting angle. A tangent 21 through the cutting edge 11 at the ball 13 and at the cylinder 14, respectively, shows that the cutting portion 10 and its circular arc 16, respectively, and the front line 17 enclose a wedge angle 22 which is less than 90 degrees in the region of the cutting edge 11. The arrangement of the cutting portion 10 is chosen in a way that a free angle 23 results with the wedge angle 22. The free angle 23 does not only extend in the region of the tip of the tooth and of the cutting edge 11, respectively, as illustrated in FIG. 1, but it exists over the entire free circular circumference of the surface 18, especially also in the region of the flanks of the tooth 3. The flanks of the tooth 3 operate in the cutting channel. This at least applies to the case in which a ball 13 and a part of a ball is used as form body 5. However, when a cylinder 14 is used, the free angle 23 extends over the length of the cutting edge 11 in a direction perpendicular to the plain of main extension 6.

FIG. 2 illustrates a front view of a tooth 3 of a saw blade 1, meaning a view in a direction opposite to arrow 7 in FIG. 1. The width of the body 2 with its protrusion 4 is to be seen. Additionally, the surface 18 of the form body 5 with its diameter in contrast to the width of the body 2 and to the protrusion 4, respectively, is to be seen. For reasons of simplifying the illustration, the surface 18 is designed as a circular surface, as it is the case with a cutting angle of 0. The diameter of the surface 18 in FIG. 2 is less than the diameter of the ball 13 according to FIG. 1. It is to be seen from FIG. 2 that the cutting edge 11 extends over a great portion of the circumference of the surface 18, especially in the region of the tooth flanks 24 which finally operate in the cutting channel. In this case, the flank angle at the tooth 3 is 180 degrees (FIG. 2). Consequently, it is approximately twice as great as it is the case in saw blades and tooth shapes known in the art. Tooth shapes in which the flank angle is slightly more than 90 degrees, meaning to have an obtuse angle, are very rarely known in the art. However, the known angles substantially differ from 180 degrees. Doubling the flank angle is an essential reason for the surprisingly great increase of the usable time of the novel saw blade 1. The flank free angle being directed perpendicular to the band running direction is 0 degrees, the flank free angle being directed in the band running direction may be 8 degrees, for example.

FIG. 3 is a similar illustration as FIG. 2, but showing the use of a cylinder 14 and of a portion of a cylinder 14, respectively. The surface 18 is illustrated in a top view. The differences concerning widths of the cylinder 14 and of the body 2 and the protrusion 4, respectively, may be well seen.

The cylinder 14 and the part of the cylinder 14 illustrated in FIG. 3, respectively, includes a surface area 25 and two faces 26. The surface area 25 is designed as a cylindrical surface and as a part of a cylindrical surface, respectively, whereas the faces 26 may be designed as plain surfaces. It makes sense to arrange great roundings 27 between the two surfaces 25 and 26. It is especially preferred to arrange the roundings 27 to extend over the entire faces 26. This means that the cylinder 14 in the direction of its axis 20 is limited by semi balls. In this case, there are the same advantages as in case of using a ball 13. When plain faces 26 are used instead, it is preferred to set the teeth 3 to attain the respective free cut.

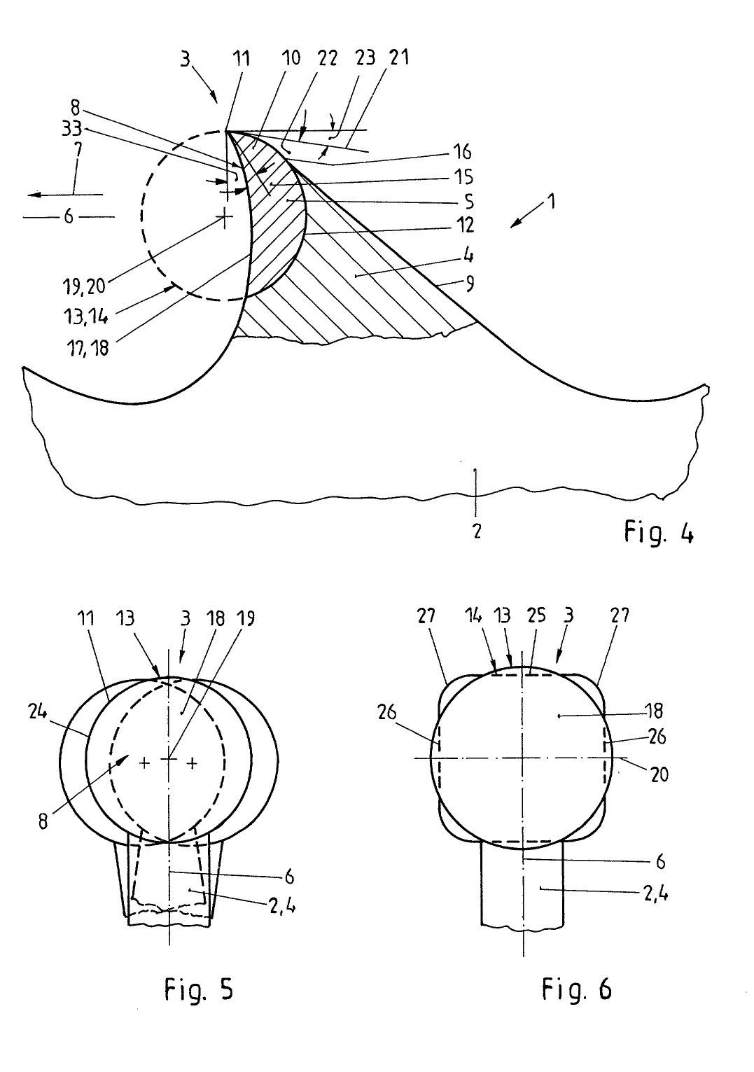

FIG. 4 is a similar illustration as FIG. 1. The surface 18 is not formed by a plain surface, but by a band surface 18. It is to be seen that the remaining part of the ball 13 and of the cylinder 14, respectively, which forms the respective tooth 3, is less than a semi ball and a semi cylinder, respectively. Again, a positive cutting angle 32 is located at the tooth 3. The sum of the cutting angle 33, the wedge angle 22 and the free angle 23 is 90 degrees. However, it is also possible to use a negative cutting angle. Even in this case, it is still possible to maintain a continuous free angle 23.

FIG. 5 is a similar illustration as FIG. 2, but showing a saw blade 1 including repeating groups each including three teeth. The first tooth in a group of teeth may be straight, meaning it is not set. The second tooth is set to the right side and the third tooth is respectively set to the left side outside of the plane of main extension 6. All teeth 3 include form bodies 5 which are formed based on a ball 13. The form bodies 5 only include one ground surface 18. The saw blade 1 may be produced at very low costs, and it has enormously great usable times, as it will be explained in the following. It is to be understood that different series of teeth may be produced in the described fashion, for example a series of five teeth 3 of which the first tooth fulfils a guiding function, whereas the following teeth are set towards different sides in pairs to widen the cutting channel.

FIG. 6 is a view of a saw blade 1 in the region of the teeth 3 which has a design corresponding to the pre-cutting and after-cutting technology. The pre-cutting tooth uses a ball 13 and the after-cutting tooth uses a cylinder 14. The overlap may be chosen in a way as it is to be seen from FIG. 6. The pre-cutting tooth operates in three sections of the cutting channel, and it empties three separate material portions in the cutting channel, whereas the after-cutting tooth operates in two sections of the cutting channel, and it empties or removes two material portions. Using a different overlap, especially by using a longer cylinder 14 including faces 26 being limited in the shape of circular arcs, it is possible to remove three material portions from the cutting channel with the pre-cutting tooth and the after-cutting tooth. In this case, the pre-cutting tooth as the highest tooth removes a chip in the middle of the cutting channel, and the after-cutting tooth removes two further chips at the sides of the cutting channel. In this way, the after-cutting tooth is responsible for realizing good cutting quality, meaning evenness and smoothness of the resulting walls of the work piece which are connected to the cutting channel. It is not necessary to set the teeth which simplifies manufacture of the saw blade 1. On the other hand, it is also possible to use series of teeth including more than two teeth, especially which said following teeth.

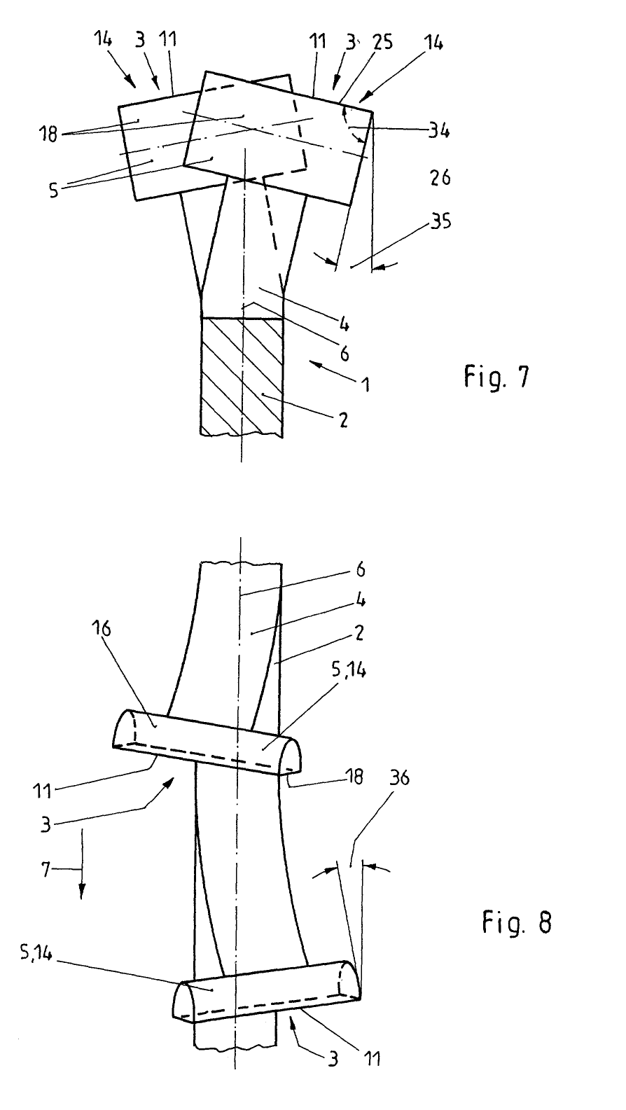

FIGS. 7 and 8 illustrate the separating portion of another novel saw blade 1. The saw blade 1 includes a repeating series of two teeth 3 which are alternately set to the left and to the right outside the plane of main extension 6. A part of a cylinder 14 is inserted at each protrusion 4 as form body 5. The part of the cylinder 14 is smaller than a semi cylinder, and at its side being directed in the band running direction according to arrow 7, it includes the surface 18. The surface 18 in combination with the circular arc 16 limiting the portion of the cylinder 14 towards the rear forms the cutting edge 11 at each tooth 3. Sections of cylinders 14 the faces 26 of which are connected to the surface area 27 without roundings are used as form bodies 5. Consequently, the flank angle 34 at the tooth 3 is 90 degrees, and the flank free angle 35 perpendicular to the band running direction according to arrow 7 is 10 degrees, for example, as this is illustrated in FIG. 7. During the setting process, the respective tooth is not only thoroughly bent to be located outside the plane of main extension, but it is also located in a turned position, as this is to be seen from FIG. 8. Accordingly, there is a free flank angle 36 in a direction opposite to the band running direction according to arrow 7 of 8 degrees, for example. The edge of each tooth 3 which works at the cutting channel is rounded due to the use of the saw blade and resulting wear such that the flank angle which once was approximately 90 degrees is changed and rounded, respectively, towards 180 degrees. Consequently, there is a similar effect as this has been described with respect to the flank angle of FIG. 2.

The saw blade 1 according to FIGS. 7 and 8 is very easy to produce. The protrusions 4 are produced at the body 2 in an identical form, for example by milling. Then, the cylinders 14, for example as finished form bodies 5 including the surface 18, are fixed at the protrusions 4 in the correct relative position. Finally, the teeth are set to the right and to the left in an alternating way. It is also possible to fix full cylinders 14 at the protrusions 4, and to set the teeth after grinding the surfaces 18.

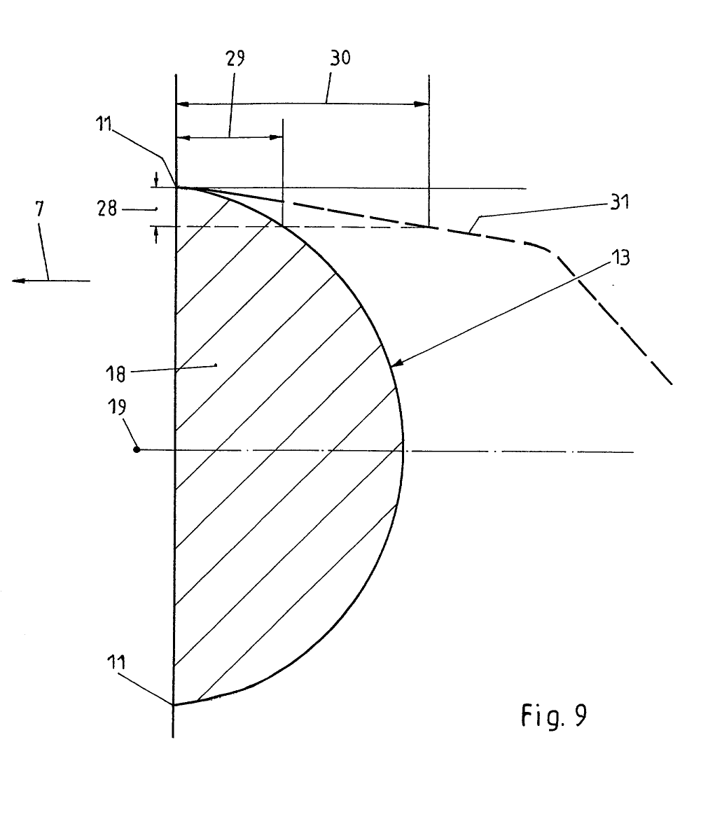

FIG. 9 illustrates a section through a semi ball about the center 19. The continuous line shows the section through a tooth 3 of the inserted ball 13 compared to a tooth known from the prior art which is illustrated by a dashed line. The section may be taken in the same relative position as in the illustrations of FIGS. 1 and 4. FIG. 7 at the same time also illustrates sections in different angled positions over the entire circumference of the cutting edge 11.

The different length of wear marks close to the cutting edge 11 may be explained by a comparison of the novel saw blade with prior art saw blades. Assuming wear 28, with the novel saw blade 1 including the ball 13 a length 29 of the wear mark results. The length 29 is substantially less than the length 30 of the wear mark resulting at the same wear in the prior art. This is caused by the fact that the surface of the ball and of the circle, respectively, rebounds increasingly more than a plain ground surface 31 being located at a tooth 3 in the region of the tip of the tooth known in the prior art. The shorter wear marks and the wear resulting in the wear marks are less than in the prior art. Consequently, the saw blade 1 may be used for a longer period of time although it is very simple to manufacture.

It is imaginable that a comparatively greater length is used for cutting in the direction of the contour of the cuffing edge 11. The novel saw blade in its simplest embodiment—only using identical unset teeth—at each tooth uses a cutting portion extending over the entire width of the cutting channel.

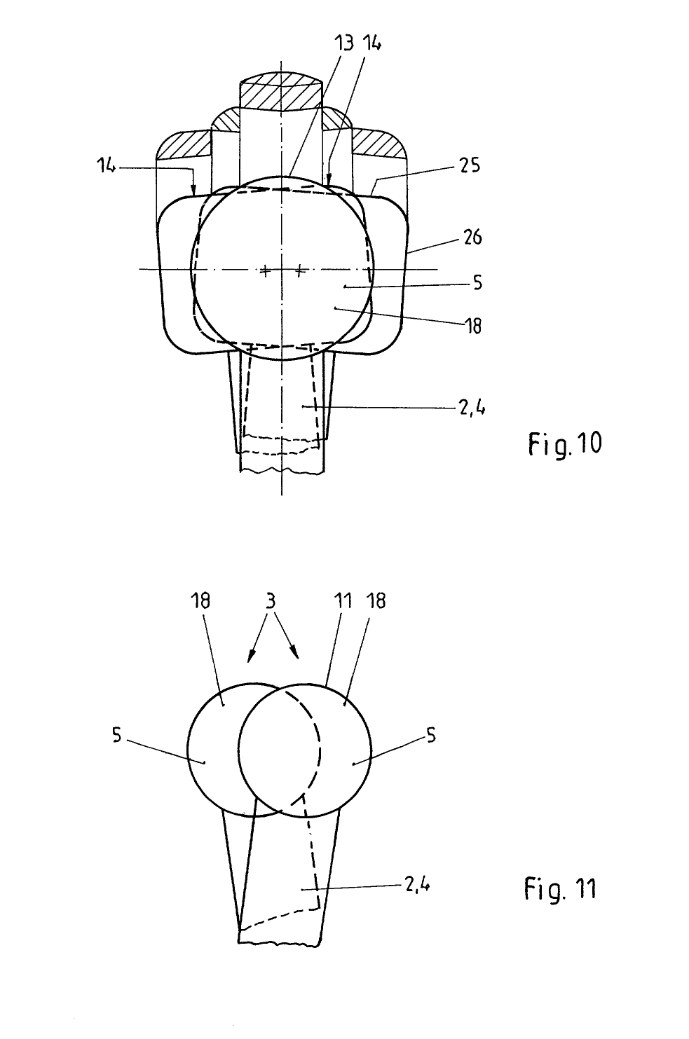

FIG. 10 illustrates another exemplary embodiment of the novel saw blade 1. The novel saw blade 1 includes groups of teeth including three teeth. The first tooth in the group of teeth is formed by the use of a ball 13. The two following teeth being arranged to be alternately set are formed by the use of a cylinder 14. The cross section of the removed chips is illustrated in the projection. It is to be seen that each tooth 3—in case of respective forward feed—only removes its own portion of the chips from the cutting channel. There is no overlap of the chips in a direction transverse to the cutting channel. Consequently, the arrangement of the teeth in the series of teeth is unlimited.

FIG. 11 finally illustrates another very simple exemplary embodiment of the novel saw blade 1 including teeth 3 which each are formed by portions of balls 13. The teeth 3 are alternately set to the left and to the right. In this embodiment, the respective surface 18 of each tooth 3 also is the only ground surface. In this way, grinding expenditure is substantially reduced. Setting the teeth is a production process which does not substantially raise the cost of manufacture. Contrary to FIG. 2, FIG. 9 shows a different ratio of diameters of the balls 13 with respect to the width of the body 2. In FIG. 9, balls 13 of comparatively little surplus diameter are used in a way that it is desired to set the teeth 3.

Many variations and modifications may be made to the preferred embodiments of the invention without departing substantially from the spirit and principles of the invention. All such modifications and variations are intended to be included herein within the scope of the present invention, as defined by the following claims.

We claim:

1. A saw blade, comprising:
an elongated body having a longitudinal edge and defining a plane of main extension;
a plurality of protrusions each being located in the region of said longitudinal edge and each including a seat;
a plurality of form bodies each being made of hard cutting material, having a cross section and being connected to one of said seats,
each cross section of said form bodies in the plane of main extension at a side facing said respective seat being limited by a line in the form of a circular arc and at a side facing away from said respective seat being limited by a front line of a surface,
the line in the form of a circular arc and the front line enclosing a wedge angle which is less than approximately 90 degrees and being designed and arranged to form a free angle;
a plurality of cutting portions each extending approximately transverse with respect to the plane of main extension; and
a plurality of teeth each being formed by one of said protrusions and said respective form body.

2. The saw blade of claim 1, wherein at least one of said form bodies is designed as a part of a ball.

3. The saw blade of claim 1, wherein at least one of said form bodies is designed as a part of a cylinder.

4. The saw blade of claim 2, wherein only the surface limiting said form body at the side facing away from said seat is ground.

5. The saw blade of claim 3, wherein only the surface limiting the form body at the side facing away from said seat is ground.

6. The saw blade of claim 1, wherein the surface is designed as a plain surface.

7. The saw blade of claim 2, wherein the surface is designed as a plain surface.

8. The saw blade of claim 3, wherein said surface is designed as a plain surface.

9. The saw blade of claim 4, wherein said surface is designed as a plain surface.

10. The saw blade of claim 5, wherein said surface is designed as a plain surface.

11. The saw blade of claim 2, wherein said part of said ball is less than a semi ball.

12. The saw blade of claim 3, wherein said cylinder includes a surface area, two faces and an axis, said part of said cylinder in a transition region being located between said surface area and said faces having a rounded design, and the axis being located to be perpendicular with respect to the plane of main extension.

13. The saw blade of claim 1, wherein at least some of said teeth are set.

14. The saw blade of claim 1, wherein said saw blade is designed to cut abrasive materials.

15. A saw blade for cutting abrasive materials, comprising:
an elongated body having a longitudinal edge and defining a plane of main extension;
a plurality of protrusions each being located in the region of said longitudinal edge and each including a seat;
a plurality of form bodies each being made of hard cutting material, having a cross section and being connected to one of said seats,
each cross section of said form bodies in the plane of main extension at a side facing said respective seat being limited by a line in the form of a circular arc and at a side facing away from said respective seat being limited by a front line of a plain, ground surface,
the line in the form of a circular arc and the front line enclosing a wedge angle which is less than approximately 90 degrees and being designed and arranged to form a free angle;
a plurality of cutting portions each extending approximately transverse with respect to the plane of main extension; and
a plurality of teeth each being formed by one of said protrusions and said respective form body.

16. The saw blade of claim 15, wherein at least one of said form bodies is designed as a part of a ball.

17. The saw blade of claim 15, wherein at least one of said form bodies is designed as a part of a cylinder.

18. A method of producing a saw blade, said method comprising the steps of:
forming a plurality of protrusions at a longitudinal edge of an elongated body;
forming a seat at each of the protrusions;
connecting a form body being made of hard cutting material to each of the seats;
forming a surface at each of the form bodies at a side facing away from the respective seat to form a cutting portion of a tooth; and
connecting a round element to each seat in a way that the cutting portion has a wedge angle which is less than approximately 90 degrees and a free angle is formed.

19. The method of claim 18, wherein the form body only at its side facing away from the seat is ground.

20. The method of claim 18, wherein at least some of the teeth are set.

21. The method of claim 19, wherein at least some of the teeth are set.

22. The method of claim 18, wherein the saw blade serves to cut abrasive materials.
